(19) United States
(12) Patent Application Publication
(10) Pub. No.: US 2012/0328144 A1
(43) Pub. Date: Dec. 27, 2012

(54) Earphones

(76) Inventors: Frank E. Dugger, Honolulu, HI (US); Yumi Fujiwara Benedicto-Dugger, Honolulu, HI (US)

(21) Appl. No.: 13/595,852

(22) Filed: Aug. 27, 2012

Related U.S. Application Data
(63) Continuation-in-part of application No. 29/373,749, filed on May 17, 2011.
Application No. 29/373,749 is a continuation-in-part of application No. 29/373,750, filed on May 17, 2011.
Application No. 29/373,750 is a continuation-in-part of application No. 29/373,751, filed on May 17, 2011.

(51) Int. Cl. H04R 1/10

(52) U.S. Cl. 381/384

(57) ABSTRACT

This invention provides novel earphones. In one embodiment, the earphones are configured for listening to music from a bust-mounted media player. In another embodiment, the earphones are configured for listening to music from an arm mounted media player.

### CROSS-REFERENCE TO RELATED APPLICATIONS

This application is a continuation in part of U.S. patent application Ser. Nos. 29/373,749, 29/373,750, and 29/373,751, filed 17 May 2011, which are hereby incorporated by reference.

### TECHNICAL FIELD

The present invention relates to earphones.

### BACKGROUND

Earphones are commonly used to listen to audio from a media player. Standard earbud cables are about 1.2 meters in length and comprise a splitter such as a “knot” at an intermediate location between an audio plug and the earbuds, which splits a single cable into two separated cables of equal length. Other variations have also been also been produced.

Harpin (2010/0155438) describes an arm band used to strap a media player to a user's arm. However, Harpin does not teach a set of earphones having reduced cable lengths or earphones having offset cable lengths.

Petitt (2011/0219522) describes a carrier for an audio device that attaches to a strap at the back of a user's headwear. Petitt also describes earphones having cords with a length of less than 12 inches. However, Petitt does not teach earphones having reduced cable lengths with a cable splitter positioned less than about 7 cm from the plug.

What are needed in the art are earphone designs for the athletic use of media players mounted on the upper body. The earphones should provide ample speaker wire to allow movement during exercise without tangling, chafing, bouncing, or pulling.

### SUMMARY OF THE INVENTION

Among the various embodiments described herein are earphone sets useful for listening to audio from a media player mounted to the upper body of a user, such as the bust, upper arm, head, or neck area (e.g. collar).

A set of earphones of the present invention comprises:
a. a first speaker and a second speaker, each configured for placement about the ear;
b. a plug configured for interfacing with an audio output jack of a media player; and
c. a first speaker cable and a second speaker cable, wherein each cable is:
   i. at a first cable end, operably linked to a respective first or second speaker; and
   ii. at a second cable end, operably linked to the plug for conducting audio signals from the plug to the respective speakers.

The first and second speaker cables are, at the first cable end, independently movable, at the second cable end, joined together into a common member. Optionally, the common member is the plug or, alternatively, is optionally a splitter (e.g. knot) of a third cable that is itself coupled to the plug.

A first aspect of the invention provides a set of earphones, wherein the sum of the lengths of the first cable and the second cable (‘inter-speaker length’) is less than 90 cm, and the common member has a distance of less than about 7 cm from the plug. Optionally, the common member is the plug or is a splitter having a distance of less than 6 cm from the plug. Optionally, the first and second cables have substantially the same length (non-offset) or different lengths (offset).

Optionally, said distance of audio-conducting member (e.g. a third cable) between the common member from the plug (“common member to plug length”) is any of: less than about 6 cm, less than about 5 cm, less than about 4 cm, less than about 3 cm, less than about 2 cm, less than about 1 cm, or 0 cm (i.e. the common member is the plug).

Optionally, the sum of the lengths of the first speaker cable and the second speaker cable (‘inter speaker length’) is any of: less than about 72 cm, less than about 66 cm, or less than about 62 cm. In an alternative embodiment, the length of each of the first and second speaker cables is any of: less than about 36 cm, less than about 33 cm, or less than about 31 cm.

Optionally, the sum of the lengths of the first speaker cable and the second speaker cable (‘inter speaker length’) is any of: about 40 cm to about 90 cm, about 40 cm to about 72 cm, about 40 to about 62 cm, about 50 to about 62 cm, or about 50 cm to about 72 cm In an alternative embodiment, the length of each of the first and second speaker cables is any of: about 20 cm to about 45 cm, about 20 cm to about 36 cm, about 20 to about 36 cm, or about 25 to about 36 cm.

Optionally, the maximum speaker to plug distance is any of: less than about 45 cm, less than about 36 cm, or less than about 33 cm. In an alternative embodiment, the maximum speaker to plug distance is any of: about 20 cm to about 45 cm, about 20 cm to about 36 cm, about 20 to about 31 cm, or about 25 to about 36 cm.

The invention also contemplates any combination of the above-taught embodiments of the first aspect of the invention.

A second aspect of the invention provides a set of offset splitter type earphones. The earphones comprise a third cable coupled at one end to a plug and coupled at the other end to the second ends of the first and second cables (e.g. by a splitter), wherein the first and second speaker cables have different lengths (offset). Optionally, the maximum speaker-plug distance is less than about 90 cm (e.g. less than about 80 cm, less than about 70 cm, about 55 cm to about 80 cm, or about 55 cm to about 70 cm).

Optionally, the shorter of the first and second speaker cables has a length of greater than about 13 cm (e.g. at least about 15 cm, about 13 cm to about 35 cm, about 15 cm to about 21 cm, or about 13 cm to about 21 cm).

Optionally, the inter-speaker distance between the first speaker and the second speaker (‘inter-speaker length’) is less than 60 cm (e.g. about 35 to about 60 cm, about 35 cm to about 57 cm, or about 42 cm to about 54 cm).

Optionally, the longer of the first and second speaker cables has a length of less than about 50 cm (e.g. less than about 48 cm, about 24 cm to about 48, about 24 cm to about 40 cm, about 28 to about 36 cm, or about 33 cm).

Optionally, the third cable has a length of about 10 cm to about 46 cm (e.g. about 20 cm to about 40 cm, about 30 cm to about 36 cm, or about 33 cm).

Optionally, the ratio of the length of the shorter of the first and second cables to the length of the longer of the first and second cable is from 1:4 to about 3:4 (e.g. about 3:8 to about 5:8, about 7:16 to about 11:16, or about 1:2).

Optionally, the ratio of the length of the third cable to the length of the longer of the first and second cables is any of: about 3:4 to about 2:1 (e.g. about 3:4 to about 3:2, about 4:5 to about 5:4, or about 1:1).

Optionally, the ratio of the length of the third cable to the length of the shorter of the first and second cables is from about 3:8 to about 2:1 (e.g. about 1:2 to about 2:1, about 2:3 to about 3:2, or about 2:1).

Optionally, the ratio of the length of the third cable to the sum of the lengths of the first cable and the length of the second cable is about 3:5 to about 5:3 (e.g. about 2:3 to about 3:2, or about 2:3).

Optionally, the second cable is about 33 cm in length, the first cable is about 18 cm in length (e.g. 17.8 cm), and the third cable is about 33 cm in length. Alternatively, the earphones have cable lengths selected from the sets listed in Table 1.

The invention also contemplates any combination of the above-taught embodiments of the second aspect of the invention.

In any embodiment taught herein, the speakers are optionally earbuds or canal phones.

In any embodiment taught herein, the plug is optionally a TRS plug or a stereo plug (e.g. 2.5 mm, 3.5 mm, or USB plug).

In any embodiment taught herein, the speakers are optionally earbuds or canal phone and the plug is optionally a TRS plug or a stereo plug (e.g. 2.5 mm, 3.5 mm, or USB).

In any embodiment taught herein, the speakers optionally comprise a waterproof housing

The invention also provides a method of listening to audio comprising plugging earphones taught herein into an audio jack of a media player mounted on the user's upper body. Optionally, the upper body is an arm (e.g. upper arm or forearm), collar area, or head.

The invention also provides a kit comprising earphones taught herein and a body mount for a media player. Optionally, the body mount is an arm mount such as an arm strap. Optionally, the body mount is a collar mount such as a clip. Optionally, the body mount is a head mount such as a head strap or hat-mount such as a clip.

### BRIEF DESCRIPTION OF THE DRAWINGS

FIG. 1 depicts an embodiment of the second aspect present invention.

FIG. 2 depicts an embodiment of the first aspect the present invention.

FIG. 3 depicts an embodiment of the first aspect of the present invention.

### DETAILORED DESCRIPTION OF THE INVENTION

As used here, the following definitions and abbreviations apply.

“Bust” means the portion of the upper body including the upper arm, shoulders, neck area (e.g. including a collar), and head area.

“Cable” or “speaker cable” means a flexible member housing at least one audio-conducting member. In one embodiment, a cable is formed by insulating an audio-conducting member (e.g. pair of wires) with flexible insulation such as rubber.

“Conductively linked” or “operably linked” means that one component is connected to another component in a manner that can transmit an audio signal between the two components. For example, plug can be operably linked to a speaker by coupling one end of a speaker cable to the plug and another end of the speaker cable to the speaker. As an alternative speaker, a single speaker cable housing two audio signals can be coupled to the plug at one end and to a common member (e.g. splitter) at another end, wherein the splitter is coupled to one or more speaker cables that each house one or more of the audio conducting member connected to at least one speaker.

“Exemplary” (or “e.g.” or “by example” or “such as”) means a non-limiting example.

“Inter-terminal length” means the total length of cable between two terminals. Examples of inter-terminal lengths include speaker-plug length and inter-speaker length.

“Inter-speaker length” or “Inter-speaker distance” means the inter-terminal length between the speakers.

“Maximum inter-terminal length” or “Maximum inter-terminal distance” means the longest of all inter-terminal lengths. In some embodiments the maximum inter-terminal length is a speaker-plug length. In other embodiments, the maximum inter-terminal length is a speaker-speaker length.

“Maximum speaker-plug length” or “Maximum speaker-plug distance” means the longest of all speaker-plug lengths.

“Minimum speaker-plug length” or “Minimum speaker-plug distance” means the shortest of all speaker-plug lengths.

“Speaker-plug length” or “Speaker-plug distance” means the inter-terminal length between the speaker and the plug.

“Terminal” means plug or speaker.

“Upper body” means the portion of a user from the stomach to the top of the head. Upper body parts include the bust and arms.

### Overview

Earphones of the present invention utilize components (e.g. plug and cables) comprising cables as audio-conducting members to operably link a sound output jack of a media player to speakers such that the audio signal is conducted from plug to speaker.

### Cables

Earphones of the present invention comprise flexible cables comprising an audio-conducting member (‘speaker cables’ or ‘cables’). A useful speaker cable is any flexible length of audio-conducting member.

According to the present invention, earphones comprise at least a first cable and a second cable, each operably linked at one end to the plug and operably linked at the other end to respective speakers. A cable can be operably linked to the plug, e.g. by coupling the audio-conducting member to the audio-conducting member of another cable that is coupled to the plug. A cable can be operably linked to a speaker in the same manner.

In one embodiment, the first and second cables are directly coupled to the plug.

In an alternative embodiment, the first and second cables joined to or into a common third cable. The third cable can be any speaker cable comprising a first audio-conducting member coupled at one end to the audio-conducting member of the first cable, and a second audio-conducting member coupled at one end to the audio-conducting member of the second cable. The other ends of the first and second audio-conducting member are optionally coupled to the plug. Optionally, the third cable is formed by marrying together two speaker cables. Optionally, the audio-first and second audio-conducting members share a common housing.

In one embodiment, earphone sets (‘earphones’) of the present invention comprise first and second audio conducting members provided in any configuration that conducts one or more audio signals from the plug to respective speakers. Proximal to the speakers, the first and second audio-conducting members are comprised (‘housed’) in independent cables (i.e. movable with respect to each other), a first cable and a second cable respectively. Proximal to the plug, the first and second audio-conducting members are housed by a common housing. The common housing can be the plug itself or a third cable connected to the plug at one end and to the first and second cables at another end.

In one embodiment, the audio-conducting members are collectively configured conducting a stereo signal. For example, the first audio conducting member can be configured to conduct a first audio signal from the plug to the first speaker and the second audio conducting member can be configured for conducting a second audio signal from the plug to the second speaker. Such a configuration is well known in the art, e.g. as is typically seen in stereo earphones. Alternatively, the cables can be configured for conducting a mono signal.

Useful audio conducting members include those configured to provide electrically conductive cables, fiber-optic cables, and sound wave-conducting cables.

In one embodiment, the audio conducting members comprise electrically conductive audio conducting members such as metal wires. Electrically conductive members can be configured for conducting either an analog or a digital signal. As an example, an audio conducting member coupling a speaker to the plug can comprise a positive wire and a negative or “ground” wire configured collectively to conduct a first audio signal from the plug to the speaker. Other examples of electrically conductive members are well known in the art.

In one embodiment, the audio conducting members comprise fiber optic members. Fiber optic members, also known as fiber optic cables can be used to conduct a digital audio signal. Examples of fiber optic cables are well known in the art.

In one embodiment, the cables comprise a sound-wave conductive cable such as a hollow tube.

Cable Configurations

In one embodiment, earphones of the present invention comprise at least a first cable and a second cable comprising first and second audio-conducting members independently movable with respect to each other (“two discrete cables”), each cable operably linking a respective speaker to the plug. The two discrete cables are joined to respective speakers on one end and joined to a common housing on another end. The common housing can be any housing that comprises both the first audio conducting member and the second audio conducting member.

In one embodiment, the common housing is the plug (‘non-splitter’ type earphones). In another embodiment, the common housing is a third cable joined to the plug at a first end and joined to the two discrete cables at a second end, e.g. by splitter located at the second end of the .third cable (‘splitter’ type earphones)

In one embodiment, the cable lengths of the first and second cables are different (‘offset’). In another embodiment, the cable lengths have substantially the same length (‘not offset’).

Earphones can also be of any combination of splitter/non-splitter and offset/non-offset types. For example, the earphones can be of the following types: splitter-offset, splitter-non-offset, non-splitter-offset, and non-splitter-non-offset. Non-offset configurations are useful, for example, for plugging into a media player mounted on the centerline of the user (e.g. back of collar, back of hat, or middle of upper chest). Offset configurations are useful, for example, for plugging into a media player mounted off the center line of the user, e.g. on an upper arm of the user, the side of the collar, or the side of a hat. Non-splitter configurations are useful, for example, for plugging into a media player mounted in proximity to the users, ears, e.g. the hat, or the upper chest. Splitter configurations, especially those with a longer third cable (e.g. longer than about 20 cm), are useful, for example, for plugging into a media player mounted relatively distal to the ears, e.g. the upper arm or the shoulder or the lower chest. Splitter configurations with a shorter third cable (e.g. shorter than about 6 cm such as about 4 cm or shorter) can be useful, for example, for mounting more proximal to the ears (e.g. collar or hat).

In one embodiment, the earphones comprise a splitter. A splitter, also known as a “knot” or a “stay” can be any device that combines the respective the audio-conducting members of the first and second cables into a common third cable. Alternatively, the splitter can be any device that joins or marries together the audio conducting members of discrete first and second cables into a common third cable. Optionally, the splitter is configured to provide a durable securement device for jointing or marrying together the audio conducting members or cables thereof. Examples of such splitters are well known in the art. For example, the splitter can be a plastic member secured at the junction of the first, second and third cables. Among other functions, a splitter can provide a fixing mechanism to ensure that the first and second cables are not pulled apart.

When a splitter is used, the third cable can be configured in any manner that conducts a plurality of audio signals alongside each other. For example, the third cable can comprise first and second audio conductive members (e.g. two pairs of positive and ground wires). Alternatively, the third cable can be configured in any manner that operably links the first and second cables to the plug or carries the audio signals for both speakers (e.g. the third cable comprises a positive wire for the first speaker, a positive wire for the second speaker, and a common ground). Examples of such configurations for the first cable are well known in the art.

In one embodiment, the earphones comprise a splitter, and the third cable comprises a plurality of insulation tubes joined or married alongside each other (e.g. by adhesive, molding, or other fixing-means), each tube housing respective audio conducting members. For example, the third cable can be produced by aligning two discrete cables each comprising a positive and ground wire, and marrying the two cables together for only a portion of their length, thereby providing the non-married segments as the first and second cables and the married portion as the third cable. A splitter can then be fixed at the junction where the married segments become separated to insure that the married segments are not forcibly separated.

In one embodiment, the earphones comprise a splitter and the third cable comprises a single tube of insulation housing a portion of the first and second audio conducting members.

In one embodiment, the earphones are of the splitter type and the first and second cables are offset, i.e. have different lengths. Examples of lengths for the first, second, and third cables are listed in Table 1. These configurations are useful for plugging into an arm-mounted media player of users of various sizes.

TABLE 1
Cable Lengths for Earphones of the Offset, Splitter Type

| | 3^{rd} Cable | 2nd Cable | 1st Cable |
|---|---|---|---|
| Set | (cm) | (cm) | (cm) |
| 1 | <50 | >13 | <50 |
| 2 | <50 | 13-30 | <50 |
| 3 | <50 | 13-25 | <50 |
| 4 | <50 | 15-21 | <50 |
| 5 | 20-50 | >13 | 20-50 |
| 6 | 20-50 | 13-30 | 20-50 |
| 7 | 20-50 | 13-25 | 20-50 |
| 8 | 20-50 | 15-21 | 20-50 |
| 9 | 25-45 | >13 | 25-45 |
| 10 | 25-45 | 13-30 | 25-45 |
| 11 | 25-45 | 13-25 | 25-45 |
| 12 | 25-45 | 15-21 | 25-45 |
| 13 | 26-40 | >13 | 26-40 |
| 14 | 26-40 | 13-30 | 26-40 |
| 15 | 26-40 | 13-25 | 26-40 |
| | 26-40 | 15-21 | 26-40 |
| | <50 | >13 | 20-50 |
| | <50 | 13-30 | 20-50 |
| | <50 | 13-25 | 20-50 |
| | <50 | 15-21 | 20-50 |
| | <50 | >13 | 25-45 |
| | <50 | 13-30 | 25-45 |
| | <50 | 13-25 | 25-45 |
| | <50 | 15-21 | 25-45 |
| | <50 | >13 | 26-40 |
| | <50 | 13-30 | 26-40 |
| | <50 | 13-25 | 26-40 |
| | <50 | 15-21 | 26-40 |
| | | >13 | 20-50 |
| | | 13-30 | 20-50 |
| | | 13-25 | 20-50 |
| | | 15-21 | 20-50 |
| | | >13 | 25-45 |
| | | 13-30 | 25-45 |
| | | 13-25 | 25-45 |
| | | 15-21 | 25-45 |
| | | >13 | 26-40 |
| | | 13-30 | 26-40 |
| | | 13-25 | 26-40 |
| | | 15-21 | 26-40 |
| | <50 | >13 | 30-36 |
| | <50 | 13-30 | 30-36 |
| | <50 | 13-25 | 30-36 |
| | <50 | 15-21 | 30-36 |
| | <50 | >13 | 30-36 |
| | <50 | 13-30 | 30-36 |
| | <50 | 13-25 | 30-36 |
| | <50 | 15-21 | 30-36 |
| | <50 | >13 | 30-36 |
| | <50 | 13-30 | 30-36 |
| | <50 | 13-25 | 30-36 |
| | <50 | 15-21 | 30-36 |
| | 20-50 | >13 | 30-36 |
| | 20-50 | 13-30 | 30-36 |
| | 20-50 | 13-25 | 30-36 |
| | 20-50 | 15-21 | 30-36 |
| | 25-45 | >13 | 30-36 |
| | 25-45 | 13-30 | 30-36 |
| | 25-45 | 13-25 | 30-36 |
| | 25-45 | 15-21 | 30-36 |
| | 26-40 | >13 | 30-36 |
| | 26-40 | 13-30 | 30-36 |
| | 26-40 | 13-25 | 30-36 |
| | 26-40 | 15-21 | 30-36 |
| | 30-36 | >13 | 30-36 |
| | 30-36 | 13-30 | 30-36 |
| | 30-36 | 13-25 | 30-36 |
| | 30-36 | 15-21 | 30-36 |
| | 33 | 18 | 33 |
| | 20-50 | 13-30 | 20-50 |
| | 25-40 | 13-25 | 25-40 |
| | <40 | <25 | <40 |

In one embodiment, the earphones are of the splitter type and the second and third cables are not offset, i.e. have substantially the same lengths. Examples of lengths for the first, second, and third cables are listed in Table 2. These configurations are useful for plugging into a bust (e.g. head or collar) mounted player of users of various sizes.

TABLE 2
Cable Lengths for Earphones of the Non-Offset, Splitter Type

| | 3rd Cable | 1^{st} & 2^{nd} Cables |
|---|---|---|
| Set | (cm) | (cm) |
| 1 | <7 | <50 |
| 2 | <7 | <45 |
| 3 | <7 | <40 |
| 4 | <7 | <35 |
| 5 | <6 | <50 |
| 6 | <6 | <45 |
| 7 | <6 | <40 |
| 8 | <6 | <35 |
| 9 | <5 | <50 |
| 10 | <5 | <45 |
| 11 | <5 | <40 |
| 12 | <5 | <35 |
| 13 | <7 | 15-40 |
| 14 | <6 | 15-40 |
| 15 | <5 | 15-40 |
| 16 | <7 | 15-35 |
| 17 | <6 | 15-35 |
| 18 | <5 | 15-35 |

In one embodiment, the maximum speaker-plug length of the earphones is less than about 50 cm. Such earphones can be of the splitter or non-splitter type and of the offset or non-offset types, or any combination thereof. Examples of useful maximum speaker-plug lengths are listed in Table 3. Such embodiments are useful, for example, for placement of a media player about the bust (e.g. collar or head) of player of users of various sizes.

TABLE 3
Maximum Speaker - Plug Length

| Set | speaker to plug length |
|---|---|
| 1 | 15-50 |
| 2 | 15-40 |
| 3 | 20-50 |
| 4 | 20-40 |
| 5 | 20-30 |
| 6 | 30-45 |

In one embodiment, the inter-speaker length of the earphones is less than about 60 cm. Examples of useful inter-speaker lengths are listed in Table 4. Any of such earphones can be of the splitter, non-splitter, offset, or non-offset types. Such embodiments are useful, for example, for placement of a media player about the upper body (e.g. bust, collar, head, or arm) of player of users of various sizes.

TABLE 4
Inter-speaker Length

| Set | Inter-speaker length |
|---|---|
| 1 | <60 |
| 2 | 28-60 |
| 3 | 43-54 |
| 4 | 46-51 |
| 5 | 28-51 |

Although the present invention provides specific examples of certain cable lengths and ratios thereof, the present invention is not limited to such specific examples. With the teachings provided herein, the skilled artisan can now provide earphones within any of the ranges for cable lengths and cable ratios disclosed and claimed herein. The skilled artisan will recognize that the various ranges of cable lengths and cable length ratios, earphone types (e.g. splitter, offset, etc.) disclosed herein are useful to fit users of various dimensions (e.g. neck circumference, head circumference, neck length, shoulder to shoulder distance, shoulder to elbow distance) and media players of various placement about the upper body.

### Speakers

Earphones of the present invention comprise at least two speakers.

The speakers can be of any type. In one embodiment, the speakers comprise an audio driver and a housing.

In one embodiment, the speaker housing is any housing configured for placement about the ear. Optionally the speaker type is selected from earbuds, circumaural, and supra-aural. Examples of housings configured for placement about the ear are well known in the art.

In one embodiment, the audio driver is any component configured to produce a sound from an audio signal. Optionally, the driver is selected from any of the following types: moving-coil, electrostatic, electret, balanced armature, or any sound-producing transducer.

In one embodiment, the speaker housings are of the earbud type. Earbud type housings are those configured for placement in the ear. Useful examples include the canalphones and outer-ear ear buds. Canalphones are configured for placement in the ear canal and typically comprise a member (e.g. stock silicone rubber, elastomer, or foam sleeves) designed to fit various ear canals to hold the speakers in place. Outer-ear buds are configured to sit inside the outer ear (e.g. in the concha and/or behind the tragus and anti-tragus), typically without entering the ear canal.

In one embodiment, the speaker housing is a waterproof earbud type. A waterproof earbud housing can optionally be any housing that provides a water tight barrier to any water-affected components inside (e.g. electrical terminals and/or audio drivers). In this embodiment, the earphones can be used in the wet conditions, e.g. while swimming. Optionally, the earphone set is a set according to the first aspect of the invention or the second aspect of the invention.

In one embodiment, the audio driver is a moving coil driver. Such a driver typically comprises a magnetic element, a diaphragm, and a voice coil. The driver can be constructed, for example, by attaching the diaphragm to the voice coil which is immersed in the magnetic field of the magnet. The diaphragm is actuated by the attached voice coil, when a current is passed through the coil. The alternating magnetic field produced by the current through the coil reacts against the static magnetic field in turn, causing the coil and attached diaphragm to move the air, thus producing sound. The magnetic element in headphones is optionally composed of ferrite or neodymium. The diaphragm can be constructed, for example, from lightweight, high stiffness to mass ratio cellulose, polymer, carbon material, or the like.

In one embodiment, the audio driver is an electrostatic driver. An electrostatic driver comprises a thin, electrically charged diaphragm (e.g. a coated PET membrane) suspended between two electrodes (e.g. perforated metal plates).

In one embodiment, the audio driver comprises a transducer selected from any of the following types: heil air motion transformer, piezoelectric film; ribbon planar magnetic, magnetostriction and plasma-ionisation.

### ALTERNATIVE EMBODIMENTS

Although the present invention is generally drawn to a set of earphones comprising two speakers and at least two cables operably linking a plug to respective speakers, the invention alternatively contemplates a set of earphones having only one speaker. For example, the invention also provides a set of earphones comprising
a. a speaker configured for placement about the ear;
b. a plug configured for interfacing with an audio output jack of a media player; and
c. a speaker cable wherein the speaker cable is:
   i. at a first cable end, operably linked to speaker; and
   ii. at a second cable end, operably linked to the plug for conducting audio signals from the plug to the speakers.

Optionally, the cable has a length of less than about 45 cm, e.g. less than about 40 cm, less than about 35 cm, or less than about 30 cm.

Optionally, the cable has a length of about 20 cm to about 45 cm, e.g. about 20 cm to about 36 cm, about 20 to about 31 cm, or about 25 to about 36 cm.

Optionally, the plug is a 3.5 mm plug or 2.5 mm plug (e.g. mono plug).

Optionally, the plug is a Tip Sleeve (“TS”) plug, e.g. 3.5 mm plug.

Optionally, the speaker is an earbud or cannalphone (e.g. with waterproof housing)

### Plug

Earphones of the present invention comprise a plug for interfacing with an audio jack. The plug can be provided in any configuration that conductively links the audio conducting members to an audio jack of a media player.

The plug can be any audio plug, for example, a stereo plug or a mono plug.

Useful examples of plugs include: tip, ring, sleeve (TRS) plugs such as 2.5 mm or 3.5 mm TRS plugs and USB plugs.

In one embodiment, the plug is a 3.5 mm plug, for example, a stereo 3.5 mm plug. Optionally, the plug is about 3 cm in length.

In one embodiment, the plug is a USB plug, for example, a mini-USB plug or a micro USB plug.

In another embodiment, the plug is configured for transmitting the audio signals for a fiber optic cable or sound-conductive cable. Examples of such are well known in the art.

### Examples

In the following examples, the following definitions apply:

“A” is the total length of cable (including any optional splitter) between the plug and the speaker which is furthest from the plug, also referred herein as the maximum speaker-plug length.

“B” is the length of cable between the first speaker 2 and the common member where the first and second cables are joined. If present, the splitter 4, is the common member. If no splitter is present, the plug 1 is the common member.

“C” is the length of cable between the second speaker 3 and the common member.

“D” is the length of cable, if present, between the plug 1 and common member (e.g. splitter) 4, the “common member to plug length”.

“E” is the sum of length “A” and the length plug 1. When the plug 1 is a 3.5 mm TRS stereo plug, the length of the plug is optionally about 3.5 cm.

The sum of B and C is referred to as the inter-speaker length.

### Example 1

### Offset-Splitter Type Earphones

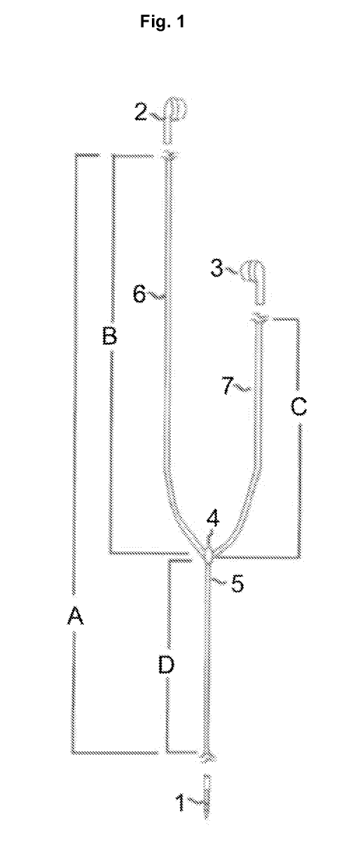

FIG. 1 depicts an embodiment of the second aspect of the present invention. The set of earphones comprises a 3.5 mm TRS stereo plug 1 and earbuds (canalphones) 2,3 as first and second speakers, respectively.

First and second cables 6,7 are connected to respective earbuds 2,3 at one cable end and joined to splitter 4 at the other cable end. A third cable 5 is connected at one end to the splitter 4 and at the other end to the plug 1.

To operably link the plug 1 to earbuds 2,3, cable 5 houses a first audio conducting member comprising a first pair of electrically conductive wires for carrying a first audio signal and a second audio conducting member comprising a second pair of electrically conductive wires for carrying a second audio signal from the plug 1 to a splitter 4 as a common member. At the splitter 4, the first and second audio conducting members are split from the third cable 5 into a respective first cable 6 and second cable 7 which carry the first and second audio signals to respective earbuds 2,3.

Cable 6 is about 33 cm in length (distance “B”). Cable 7 is about 18 cm (17.8 cm) in length (distance “C”). Cable 5 is about 33 cm in length (distance “D”).

The total length of audio-conducting member between speaker 2 and plug 1 or “maximum speaker-plug length” (distance “A”) is about 67 cm. This length can be provided by computing the sum of the distances B and D and the length of audio-conducting wire house by the splitter (e.g. about 1 cm).

The inter-speaker length (sum of distances “B” and “C”) is about 48 cm.

The ratio of B:D is about 1:1.

The ratio of B:C is about 2:1.

The ratio of D:C is about 2:1.

Surprisingly, this set of earphones is especially useful for listening to audio from a media player mounted to the arm of a user such as the upper arm. This configuration reduces tangling, chafing, pulling, and bouncing.

### Example 2

### Non-Offset Splitter Type Earphones

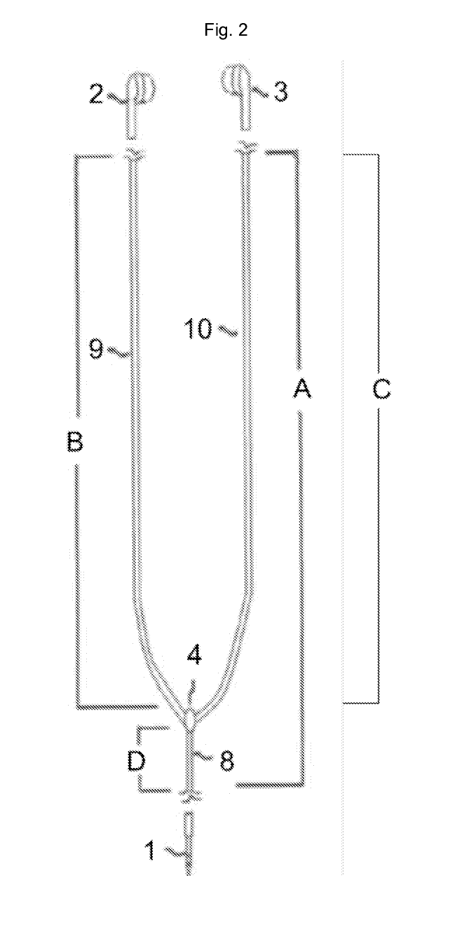

FIG. 2 depicts an embodiment of the first aspect of the present invention. The set of earphones comprises a 3.5 mm TRS stereo plug 1 as a plug and earbuds (canalphones) 2,3 as first and second speakers, respectively.

First and second cables 9,10 are connected to respective earbuds 2,3 at one cable end and joined to splitter 4 at the other cable end. A third cable 8 is connected at one end to the splitter 4 and at the other end to the plug 1.

To operably link the plug 1 to earbuds 2,3, cable 8 houses a first audio conducting member comprising a first pair of electrically conductive wires for carrying a first audio signal and a second audio conducting member comprising a second pair of electrically conductive wires for carrying a second audio signal from the plug 1 to a splitter 4 as a common member. At the splitter 4, the first and second audio conducting members are split from the third cable 8 into a respective first cable 9 and second cable 10 which carry the first and second audio signals to respective earbuds 2,3.

Cables 9 and 10 each have a length of about 23 cm (distances “B” and “C”). Cable 8 is about 4 cm in length (distance “D”). The maximum speaker-plug length (distance “A”) is about 28 cm (or 28+/−3 cm). This length can be provided by computing the sum of the distances B (or C) and D and the length of audio-conducting wire house by the splitter (e.g. about 1 cm).

The inter-speaker length (sum of distances “B” and “C”) is about 46 cm.

The ratio of B:D is about 6:1 (5.75:1).

The ratio of B:C is about 1:1.

The ratio of D:C is about 1:6 (5.75:1).

Surprisingly, this set of earphones is especially useful for listening to audio from a media player mounted to the bust of a user such as the collar or head (e.g. brim of hat) of a user. This configuration reduces tangling, chafing, pulling, and bouncing.

### Example 3

### Non-Offset Non-Splitter Type Earphones

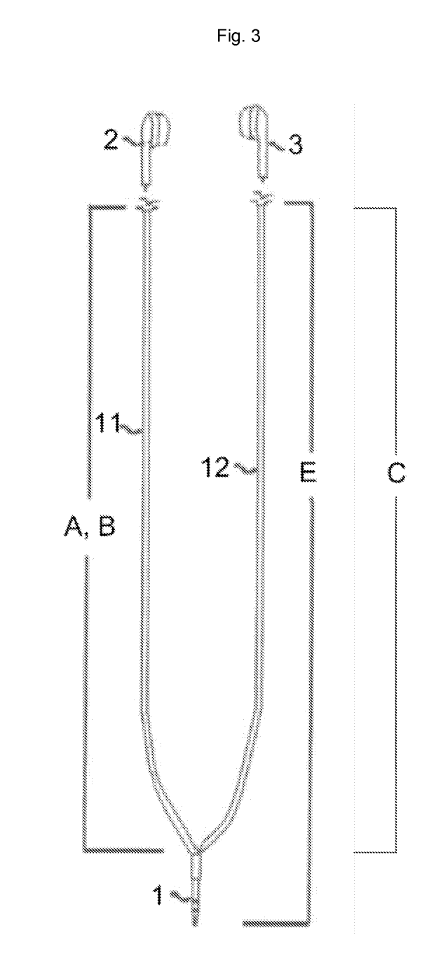

FIG. 3 depicts an embodiment of the first aspect of the present invention. The set of earphones comprises a 3.5 mm TRS stereo plug 1 and earbuds 2,3 (canalphones) as first and second speakers, respectively. The earphones do not have a splitter (i.e. the plug is the common member where the first and second cables join)

Earbud 2 is connected to plug 1 by cable 11, which houses electrical wires for carrying a first audio signal from the plug 1 to earbud 2. Earbud 3 is connected to plug 1 by cable 12, which houses electrical wires for carrying a second audio signal from the plug 1 to earbud 3.

Cables 11 and 12 each have a length of about 28 cm (distances “B” and “C”). Accordingly, the maximum speaker-plug length (distance “A”) is about 28 cm.

Optionally, distance E is about 31 cm (or 31+/−3 cm). This can be achieved by providing a TRS plug that is about 3 cm in length.

The inter-speaker length (sum of distances “B” and “C”) is about 56 cm.

The ratio of B:C is about 1:1.

Surprisingly, this set of earphones is especially useful for listening to audio from a media player mounted to the bust of a user such as the collar (e.g. shirt collar) or head (e.g. brim of hat). This configuration reduces tangling, chafing, pulling, and bouncing.

### Example 4

### Earphones Tests: First Aspect

Five sets of earphones of the first aspect of the invention were produced in the manner detailed in Example 3, except that the length of the cables was varied. The sets of earphones had symmetrical (equal length) cables with plug-speaker lengths of about 20-36 cm and no splitter. The sets of earphones are listed as sets 1-5 in Table 5 and graphically represented in FIG. 3. As these sets of headphones had no splitter, a third cable is not present (“N/A”) and therefore have a common-member to plug length of 0 cm.

TABLE 5
Earphone Sets

| | | | | | Inter- |
|---|---|---|---|---|---|
| | A (maximum | B (1^{st} | C | D | speaker |
| | plug-speaker) | L cable) | (2^{nd} cable) | (3^{rd} Cable) | length |
| Set | (cm) | (cm) | (cm) | (cm) | (cm) |
| 1 | 20 | 20 | 20 | 0 (N/A) | 40 |
| 2 | 25 | 25 | 25 | 0 (N/A) | 50 |
| 3 | 28 | 28 | 28 | 0 (N/A) | 56 |
| 4 | 31 | 31 | 31 | 0 (N/A) | 62 |
| 5 | 36 | 36 | 36 | 0 (N/A) | 72 |
| Comparator | 30 | 21 | 21 | 8.5 | 42 |
| X | | | | | |

The earphones were tested for their properties. Specifically, three sets of experiments were conducted. Experiment 1 tested sets 1-5 of the present invention and Experiments 2 each tested sets 1-5 and Comparator X. As a comparator (“Comparator X”), a symmetrical set of earphones was provided which had plug-speaker lengths of about 30 cm and a splitter 8.5 cm from the plug, with a splitter-speaker length (i.e. first and second cable lengths) of 21 cm, as listed in Table 5 and graphically represented in FIG. 2.

Experiment 1

In a first experiment, sets 1-5 of the present invention were given to testers in a 15 kilometer race (running marathon). Specifically, sets 1-5 were provided in duplicate. Each of five female athlete testers were given one of the sets and each of five male athlete testers were given one of the sets. The athletes listened to music from a collar- or hat-mounted media player while running the marathon.

Surprisingly, each of the testers reported that the earphones of the present invention earphones worked remarkably well. Specifically, the testers reported that the earphones were lightweight and did not irritate or annoy them by chafing, pulling, bouncing, or tangling substantially. This data indicates that earphones of the first aspect of the present invention provide superior properties.

After the marathon, several of the testers swapped their test set for a different set. Surprising, the female testers preferred the earphone sets with the longer cables. Specifically, female testers, which tended to have longer hair pulled back (e.g. in a ponytail) reported that sets with an inter-speaker length of 62 cm or greater provided superior properties in that they experienced no pulling or interference with their pulled back hair. This indicates that superior earphones can be provided with an inter-speaker length of greater than about 62 cm, e.g. about 62 cm about 90 cm.

Experiment 2

In a second experiment, a tester listened to music from a collar-mounted media player using each of sets 1-5 of the present invention and Comparator X while exercising. Surprisingly, the tester reported that sets 1-5 were much more comfortable and less irritating than Comparator X. Specifically, the tester was annoyed by the splitter of Comparator X, which was located 8.5 cm from the plug and frequently in contact with the tester's neck. Further, during more rigorous exercise, the tester reported that the splitter bounced and flung about, repeatedly brushing against the tester's neck, which was irritating to the tester. Even more surprising was that the tester reported hardly noticing the presence of the earphones of the present invention around the neck area. These results indicate that superior sets of earphones of the present invention comprising can be provided with a reduced common member-plug length.

In addition, the inventors inspected the location of the splitter of Comparator X relative to the tester's neck and the tendency of the splitter to bounce. Not only did the inventors conclude that superior earphones can be produced by reduction of the common member-plug length to less than 8.5 cm, but that reduction to less than about 7 cm (e.g. less than about 6 cm, less than about 5 cm, less than about 4 cm, less than about 3 cm, less than about 2 cm, or less than about 1 cm) also provide superior earphones, e.g. by reducing irritation on the neck and bouncing.

In addition, the tester indicated that the earphone of the present invention did not bounce, tangle, or chafe, as is commonly experienced with earphones of the prior art. It was determined that shorter earbud cables reduce bouncing and tangling while longer cables reduce pulling. Accordingly, superior earphones of the present invention can be provided with an inter-speaker length (e.g. twice the cable length for symmetrical configurations) of less than 90 cm to eliminate bouncing and tangling. Also, superior earphones can be produced by combining this feature with a shorter plug-common member distance (e.g. less than about 7 cm or less than about 6 cm) to eliminate contact and irritation of the common member (e.g. splitter) on the neck.

Experiment 3

In a third experiment, an exemplary set of the invention (set 3) was selected and given with Comparator X to each of 10 volunteer testers, five women and five men having heights ranging from 5′7″ to 6′2″. Exercises included running, weight lifting, and calisthenics (pull ups, jumping jacks, push ups abdominal crunches, mountain climbers, flutter kicks and jumping rope). While running, testers listened to music from a hat-mounted media player. While weight lifting, testers listened to music from a front-collar mounted media player. While performing calisthenics, testers listened to music from a front-collar mounted media player. While performing calisthenics, testers listened to music from a front-collar mounted media player or a rear-collar mounted media player.

Surprisingly, the testers reported that the earphone set of the invention was much more comfortable and less irritating than Comparator X for each of the exercises. Specifically, the testers were annoyed by the splitter of Comparator X, which was located 8.5 cm from the plug and frequently in contact with the tester's neck. The testers also reported that the splitter bounced and flung about, repeatedly brushing against their neck, which was reported as irritating to the tester. Even more surprising was that the testers reported hardly noticing the presence of the earphones of the present invention around the neck area. These results indicate that sets of earphones of the present invention comprising having a common member-plug length of less than 8.5 cm provide superior properties. Accordingly, earphones of the present invention having common member-plug length of less than 7 cm (e.g. less than about 6 cm, less than about 5 cm, less than about 4 cm, less than about 3 cm, less than about 2 cm, or less than about 1 cm) also provide superior earphones, e.g. by reducing irritation on the neck and bouncing.

Also surprising is that runners were able to slightly tuck the wires of earphones of the present invention into their hat to totally eliminate even a slight bounce effect without pulling while the same runners reported that this resulted in substantial pulling from Comparator X due to the longer common member (splitter) to plug length combined with the reduced inter-speaker length. In addition to supporting the use of earphones with no splitter, this data also supports the use of earphones having a ratio of common member to plug length:interspeaker length of less than about 1:5 (e.g. less than about 1:7 or less than about 1:10).

TABLE 6
Earphone Tests: Offset Splitter Type

[symbol]

[symbol]

indicates data missing or illegible when filed

[symbol]

A set of offset splitter type earphones of the invention were produced in the manner detailed in Example 1. Specifically, the set of earphone is listed as set 6 in Table 7 and graphically depicted in FIG. 1. As a comparator (“Comparator Y”), a set of earphones was provided, as listed in Table 7 and graphically depicted in FIG. 1.

TABLE 7
Offset Splitter Type Earphones

| | | | | | Inter- |
|---|---|---|---|---|---|
| | A (maximum | B (1^{st} | C | D | speaker |
| | plug-speaker) | L cable) | (2^{nd} cable) | (3^{rd} Cable) | length |
| Set | (cm) | (cm) | (cm) | (cm) | (cm) |
| 6 | 67 | 33 | 18 | 33 | 51 |
| Comparator | 91 | 53 | 11 | 36 | 64 |
| Y | | | | | |

Both sets of earphones were of the offset-splitter type, configured, e.g. for listing to music from an arm-mounted media player. A first cable connecting the splitter to the first earbud is longer to reach the earbud/user's ear on the opposite side of the arm-mounted media player while the second cable connecting the splitter to the second earbud is shorter to reach the earbud/user's ear on the same side as the arm-mounted media player connect the media player to the ear. The third cable connects the plug to the splitter. Set 6 of the invention and Comparator Y had different cable lengths, as can be seen from Table 7. For example, the comparator differed substantially in the total length (maximum plug-speaker length, dimension A) as well as the lengths of the first cable (dimension B) and the second cable (Dimension C).

The earphones were tested for their properties. Specifically, both sets of earphones were given to each of 10 testers, five women and five men having heights ranging from 5′7″ to 6′2″. Exercises included running, weight lifting, and calisthenics (pull ups, jumping jacks, push ups abdominal crunches, mountain climbers, flutter kicks and jumping rope).

Surprisingly, each of the testers reported that the earphones of the present invention were superior. Specifically, the testers reported that the earphone of the present invention was lightweight and did not irritate or annoy them by chafing, pulling, or bouncing substantially. This is in contrast to Comparator X, from which most testers reported substantial pulling and bouncing. This data indicates that earphones of the present invention provide superior properties.

Several testers reported general bouncing and whipping of the cables about the head, neck, and arm from Comparator Y but no testers reported bouncing and whipping of the cables from set 6 of the present invention. The earphones of the present invention provided superior features that inhibited the bouncing and whipping, namely, a shorter maximum plug-speaker length, a shorter second cable length, and a shorter inter-speaker length. The inventors discovered that each of these features alone or in concert can be tailored to control bouncing and whipping. Specifically, comparison of the cable lengths and dimensions of set 6 to Comparator Y revealed that superior earphone sets could obtained by providing one or more of the following features:
a. a maximum plug-speaker length of less than 90 cm (e.g. less than about 80 cm, less than about 70 cm, about 55 cm to about 80 cm, or about 55 cm to about 70 cm);
b. a first cable (longer of the first and second cables) having a length of less than about 50 cm (e.g. less than about 48 cm, about 24 cm to about 48, about 24 cm to about 40 cm, about 28 to about 36 cm);
c. an inter-speaker distance of less than 60 cm (e.g. about 35 to about 60 cm, about 35 cm to about 57 cm, or about 42 cm to about 54 cm).

In addition, most testers reported bouncing of the splitter and pulling at the ear from the earbud of Cable 2 of Comparator Y, with some testers reporting that their earbud actually fell out due to the pulling. No testers reported pulling at the ear or losing the earbud from Set 6. The earphones of the present invention provided a superior feature that inhibited the bouncing and pulling on the ear, namely a shorter second cable. The length of the second cable of Comparator Y had a length of 11 cm while the second cable of the earphones of the present invention (set 6) had a length of 18 cm. While listing to music, the shorter length of the second cable of Comparator Y placed the splitter in a position suspended about 2 cm above the users' shoulder such the splitter continuously bounced during exercise and pulled on the respective earbud and ear. In contrast, the longer length of the second cable of set 6 placed the splitter on the user's shoulder and prevented bouncing and pulling at the ear. The inventors discovered that this feature can be tailored to control bouncing of the splitter and pulling of the earbud at the ear. Specifically, comparison of the length of the second cable of set 6 to Comparator Y revealed that superior earphone sets can be obtained by providing the shorter of the first and second cables with a length of at least about 13 cm (e.g. at least about 15 cm, about 13 cm to about 35 cm, about 15 cm to about 21 cm, or about 13 cm to about 21 cm).

In addition, the inventors determined that superior offset splitter type earphones could also be produced on any scale (e.g. for very large (e.g. >6′2″) or petite (e.g. <5′7″) people) using novel ratios of the length of the second cable to the length of the first cable, namely a ratio ranging from 1:4 to about 3:4 (e.g. about 3:8 to about 5:8, about 7:16 to about 11:16, or about 1:2). For example, in set 6, the length of the first cable (33 cm) and the length of the second cable (18 cm) provide a ratio of about 1:2, which falls within such a range. In contrast to this, comparator Y has cable lengths of 11 cm and 53 cm, providing a ratio of about 1:5, which does not fall in the range.

Taken together, these data demonstrate that superior offset splitter type earphones of the present invention can be obtained by providing one or more of: a maximum plug-speaker length, an inter-speaker distance, the length of the shorter of the first and second cables, and the length of the longer of the first and second cables with dimensions taught herein.

The citations provided herein are hereby incorporated by reference for the cited subject matter.

What is claimed is:

1. A set of earphones comprising:
a. a first speaker and a second speaker, each configured for placement about the ear;
b. a plug configured for interfacing with an audio output jack of a media player; and
c. a first speaker cable and a second speaker cable, wherein:
i. the sum of the lengths of the first speaker cable and the second speaker cable (‘inter speaker length’) is less than about 90 cm; and
ii. each cable is:
1. at one end, operably linked to a respective first or second speaker; and
2. at another end, joined to a common member and operably linked to the plug for conducting audio signals from the plug to the respective speakers, wherein the distance of audio-conducting member between the common member and the plug (‘common member to plug length’) is less than about 7 cm.

2. The set of claim 1, wherein the common member is:
a. the plug; or
b. a splitter.

3. The set of claim 2, wherein the common member is a splitter, and the set further comprises a third cable operably linked at one end to the plug and at the other end to the splitter.

4. The set of claim 3, wherein the length of the third cable is said common member to plug length.

5. The set of claim 1, wherein the common member to plug length is less than about 6 cm, less than about 5 cm, less than about 4 cm, less than about 3 cm, less than about 2 cm, or less than about 1 cm.

6. The set of claim 5, wherein the inter speaker length is any of: less than about 72 cm, less than about 66 cm, or less than about 62 cm.

7. The set of claim 5, wherein the length of each of the first and second speaker cables is any of: less than about 36 cm, less than about 33 cm, and less than about 31 cm.

8. The set of claim 5, wherein the inter speaker length is any of: about 40 cm to about 90 cm, about 40 cm to about 72 cm, about 40 to about 62 cm, about 50 to about 62 cm, about 50 cm to about 72 cm, about 62 cm to about 72 cm, about 62 cm to about 90 cm, or about 50 cm to about 72 cm.

9. The set of claim 5, wherein the length of each of the first and second speaker cables is any of: about 20 cm to about 45 cm, about 20 cm to about 36 cm, about 20 to about 36 cm, and about 25 to about 36 cm.

10. The set of claim 5, wherein the first and second speakers are earbuds or canalphones.

11. The set of claim 5, wherein the plug is selected from: a 2.5 mm stereo plug, a 3.5 mm stereo plug, a TRS plug, or a universal serial bus (‘USB’) plug.

12. The set of claim 5, wherein the first and second speakers comprise waterproof housings.

13. The set of claim 1, wherein the inter speaker length is any of: less than about 72 cm, less than about 66 cm, or less than about 62 cm.

14. The set of claim 1, wherein the length of each of the first and second speaker cables is any of: less than about 36 cm, less than about 33 cm, and less than about 31 cm.

15. The set of claim 1, wherein the inter speaker length is any of: about 40 cm to about 90 cm, about 40 cm to about 72 cm, about 40 to about 62 cm, about 50 to about 62 cm, about 50 cm to about 72 cm, about 62 cm to about 72 cm, about 62 cm to about 90 cm, or about 50 cm to about 72 cm.

16. The set of claim 1, wherein the length of each of the first and second speaker cables is any of: about 20 cm to about 45 cm, about 20 cm to about 36 cm, about 20 to about 36 cm, and about 25 to about 36 cm.

17. The set of claim 1, wherein the first and second speakers are earbuds or canalphones.

18. The set of claim 17, wherein the plug is selected from: a 2.5 mm stereo plug, a 3.5 mm stereo plug, a TRS plug, or a universal serial bus (‘USB’) plug.

19. The set of claim 1, wherein the plug is selected from: a 2.5 mm stereo plug, a 3.5 mm stereo plug, a TRS plug, or a universal serial bus (‘USB’) plug.

20. The set of claim 1, wherein the first and second speakers comprise waterproof housings

25. The set of any of claims 1-4, wherein the common member to plug length is less than about 6 cm, less than about 5 cm, less than about 4 cm, less than about 3 cm, less than about 2 cm, or less than about 1 cm.

26. The set of claim 2, wherein the common member is the plug.

27. The set of any of the preceding claims wherein the inter speaker length is any of: less than about 72 cm, less than about 66 cm, or less than about 62 cm.

28. The set of any of claims 1-6, wherein the length of each of the first and second speaker cables is any of: less than about 36 cm, less than about 33 cm, and less than about 31 cm.

29. The set of any of claims 1-6, wherein the inter speaker length is any of: about 40 cm to about 90 cm, about 40 cm to about 72 cm, about 40 to about 62 cm, about 50 to about 62 cm, about 50 cm to about 72 cm, about 62 cm to about 72 cm, about 62 cm to about 90 cm, or about 50 cm to about 72 cm.

30. The set of any of claims 1-6, wherein the length of each of the first and second speaker cables is any of: about 20 cm to about 45 cm, about 20 cm to about 36 cm, about 20 to about 36 cm, and about 25 to about 36 cm.

31. The set of any of the preceding claims, wherein the first and second speakers are earbuds or canalphones.

32. The set of any of the preceding claims, wherein the plug is selected from: a 2.5 mm stereo plug, a 3.5 mm stereo plug, a TRS plug, or a universal serial bus (‘USB’) plug.

33. The set of any of the preceding claims, wherein the first and second speakers comprise waterproof housings.

114. A set of earphones comprising:
a. a first speaker and a second speaker, each configured for placement about the ear;
b. a plug configured for interfacing with an audio output jack of a media player; and
c. a first speaker cable and a second speaker cable, wherein:
i. the first speaker cable is shorter than the second speaker cable; and
ii. each cable is:
1. at one end, operably linked to a respective first or second speaker; and
2. at another end, joined to a splitter; and
d. a third speaker cable coupled at one end to the splitter and at another end to the plug.

115. The set of claim 114, wherein the maximum distance of audio-conducting member between the plug and any speaker (‘maximum speaker-plug distance’) is less than about 90 cm, optionally wherein the maximum speaker-plug distance is any of: less than about 80 cm, less than about 70 cm, about 55 cm to about 80 cm, or about 55 cm to about 70 cm.

116. The set of claim 115, wherein the maximum speaker-plug distance is the sum of the lengths of the third cable, the second cable, and the splitter.

117. The set of any of claims 114-116, wherein the first cable has a length greater than about 13 cm.

118. The set of claim 1117, wherein the first cable has a length selected from: at least about 15 cm, about 13 cm to about 35 cm, about 15 cm to about 21 cm, and about 13 cm to about 21 cm.

119. The set of any of claims 114-116, wherein the inter-speaker distance is less than about 60 cm, optionally wherein the inter-speaker distance is about 35 cm to about 60 cm.

120. The set of any of claims 114-116, wherein the second cable has a length of less than about 50 cm.

121. The set of claim 120, wherein the second cable has a length selected from: less than about 48 cm, about 24 cm to about 48, about 24 cm to about 40 cm, and about 28 to about 36 cm.

122. The set of any of claims 114-116, wherein the third cable has a length of about 10 cm to about 46 cm.

123. The set of claim 122, wherein the third cable has a length selected from: about 20 cm to about 40 cm, and about 30 cm to about 36 cm.

124. The set of any of claims 114-116, wherein the ratio of the length of the first cable to the length of the second cable is from 1:4 to 3:4.

125. The set of claim 124, wherein the ratio of the length of the first cable to the length of the second cable is selected from: about 3:8 to about 5:8, about 7:16 to about 11:16, and about 1:2.

126. The set of any of claims 114-116, wherein the ratio of the length of the third cable to the length of the second cable is: about 3:4 to about 2:1.

127. The set of claim 126, wherein the ratio of the length of the third cable to the length of the second cable is selected from: about 3:4 to about 3:2, about 4:5 to about 5:4, and about 1:1.

128. The set of any of claims 114-116, wherein the ratio of the length of the third cable to the length of the first cable is from about 3:8 to about 2:1.

129. The set of claim 128, wherein the ratio of the length of the third cable to the length of the first cable is selected from: about 1:2 to about 2:1, about 2:3 to about 3:2, and about 2:1.

130. The set of any of claims 114-116, wherein, the ratio of the length of the third cable to the sum of the lengths of the first cable and the length of the second cable is about 3:5 to about 5:3.

131. The set of claim 30, wherein the ratio of the length of the third cable to the sum of the lengths of the first cable and the length of the second cable is selected from: about 2:3 to about 3:2 and about 2:3.

132. The set of any of claims 118-131, wherein the first cable has a length greater than about 13 cm.

133. The set of claim 132, wherein the first cable has a length selected from: at least about 15 cm, about 13 cm to about 35 cm, about 15 cm to about 21 cm, and about 13 cm to about 21 cm.

134. The set of any of claims 120-131, wherein the inter-speaker distance is less than about 60 cm, optionally wherein the inter-speaker distance is about 35 cm to about 60 cm.

135. The set of any of claims 122-131, wherein the second cable has a length of less than about 50 cm.

136. The set of claim 135, wherein the second cable has a length selected from: less than about 48 cm, about 24 cm to about 48, about 24 cm to about 40 cm, and about 28 to about 36 cm

137. The set of any of claims 124-131, wherein the third cable has a length of about 10 cm to about 46 cm.

138. The set of claim 137, wherein the third cable has a length selected from: about 20 cm to about 40 cm, and about 30 cm to about 36 cm.

139. The set of any of claims 126-131, wherein the ratio of the length of the first cable to the length of the second cable is from 1:4 to 3:4.

140. The set of claim 139, wherein the ratio of the length of the first cable to the length of the second cable is selected from: about 3:8 to about 5:8, about 7:16 to about 11:16, and about 1:2.

141. The set of any of claims 128-131, wherein the ratio of the length of the third cable to the length of the second cable is: about 3:4 to about 2:1.

142. The set of claim 141, wherein the ratio of the length of the third cable to the length of the second cable is selected from: about 3:4 to about 3:2, about 4:5 to about 5:4, and about 1:1.

143. The set of any of claims 130-131, wherein the ratio of the length of the third cable to the length of the first cable is from about 3:8 to about 2:1.

144. The set of claim 143, wherein the ratio of the length of the third cable to the length of the first cable is selected from: about 1:2 to about 2:1, about 2:3 to about 3:2, and about 2:1.

145. The set of any of claims 114-131, wherein the first and second speakers are earbuds or canalphones.

146. The set of any of claims 114-131, wherein the plug is selected from: a 2.5 mm stereo plug, a 3.5 mm stereo plug, a TRS plug, or a universal serial bus (‘USB’) plug.

147. The set of any of claims 114-131, wherein the first and second speakers comprise waterproof housings.

148. The set of any of claims 1-20, wherein the plug is a TRS plug and the speakers are earbuds or canalphones.

149. The set of any of claims 114-144, wherein the plug is a TRS plug and the speakers are earbuds or canalphones.

150. The set of any of claims 5-33, wherein the common member is the plug.
